(19) United States
(12) Patent Application Publication
(10) Pub. No.: US 2006/0233667 A1
(43) Pub. Date: Oct. 19, 2006

(54) Joint-diagnostic spectroscopic and biosensor apparatus

(75) Inventor: James Samsoondar, Cambridge (CA)

Correspondence Address: BERESKIN AND PARR, 40 KING STREET WEST, BOX 401, TORONTO, ON, M5H 3Y2, CA

(73) Assignee: Chromedx Inc.

(21) Appl. No.: 11/108,912

(22) Filed: Apr. 19, 2005

(51) Int. Cl. G01N 21/00

(52) U.S. Cl. 422/82.05

(57) ABSTRACT

Some embodiments of the invention provide a single apparatus that is suitable for both spectroscopic and biosensor measurement of a fluid sample. Once the fluid is transferred to the apparatus, the apparatus can be inserted into a slot in a diagnostic measurement instrument for rapid fluid analysis. Because the apparatus is small and no pretreatment of the fluid is necessary, the diagnostic measurement instrument may be in the form of an inexpensive hand-held instrument, which could be used at the site of patient care. In some very specific embodiments, the apparatus is provided with two independent flow paths for analysis of the fluid. One flow path includes an optical chamber and the second flow path includes at least one biosensor.

### FIELD OF THE INVENTION

The invention relates to blood analysis, and, in particular to a joint-diagnostic spectroscopic and biosensor apparatus.

### BACKGROUND OF THE INVENTION

There are many medical diagnostic tests that require a fluid, for example without limitation, blood, serum, plasma, cerebrospinal fluid, synovial fluid, lymphatic fluid, calibration fluid, and urine. With respect to blood, a blood sample is typically withdrawn in either an evacuated tube containing a rubber septum (a vacutainer), or a syringe, and sent to a central laboratory for testing. The eventual transfer of blood from the collection site to the testing site results in inevitable delays. Moreover, the red blood cells are alive and continue to consume oxygen during any delay period, which in turn changes chemical composition of the blood sample in between the time the blood sample is obtained and the time the blood sample is finally analyzed. In many cases reagents are also added to a blood sample to hemolyze red blood cells before the analysis is eventually carried out. Sometimes chemical analysis is performed, requiring more reagents. Such reagents dilute a blood sample and cause significant errors if the volume of the blood sample is small.

One example of a blood analysis technique that is affected by the aforementioned sources of error is co-oximetry. Co-oximetry is a spectroscopic technique that can be used to measure the different Hemoglobin (Hb) species present in a blood sample. The results of co-oximetry can be further evaluated to provide Hb Oxygen Saturation (sO₂) measurements. If the blood sample is exposed to air the Hb sO₂ measurements are falsely elevated, as oxygen from the air is absorbed into the blood sample. Co-oximetry also typically requires the hemolyzing of red blood cells to make the blood sample suitable for spectroscopic measurement. Hemolysis can be accomplished by chemical means or through the action of sound waves. The parameters measured in blood by spectroscopic techniques or spectrometry are limited by the absorbance of electromagnetic radiation (EMR) by the parameters measured. For example, without limitation, hydrogen ions (which determine pH) and electrolytes, which do not absorb EMR because they do not contain covalent bonds that can absorb EMR. Thus, these important parameters must be measured by other means.

Another example of a blood analysis technique that is affected by the aforementioned sources of error is blood gases. Traditionally, blood gas measurement includes the partial pressure of oxygen, the partial pressure of carbon dioxide, and pH. From these measurements, other parameters can be calculated, for example, Hb sO₂. Blood gas and electrolyte measurements usually employ biosensors. Bench-top analyzers are available, which (1) measure blood gases, (2) perform co-oximetry, or (3) measure blood gases and perform co-oximetry in combination. Some combinations of diagnostic measurement instruments also include electrolytes, making such instrument assemblies even larger. Because these instruments are large and expensive, they are usually located in central laboratories. Biosensor technology is also limited by the blood parameters it can measure. For example, biosensors are not currently available for measuring the Hb species measured by the available co-oximeters.

Preferably, blood gases and co-oximetry are measured in arterial blood collected in a syringe, since arterial blood provides an indication of how well venous blood is oxygenated in the lungs. There are many benefits in providing these blood tests near or at the point of care of patients, but these are usually limited by the size and cost of the diagnostic measurement instruments. Those skilled in the art will appreciate that, as a non-limiting example, assessment of the acid-base status of a patient requires both the measurement of hemoglobin (Hb) species in the blood and the blood pH.

### SUMMARY OF THE INVENTION

According to an aspect of an embodiment of the invention there is provided a fluid measurement apparatus comprising: (a) a housing; (b) an inlet within the housing for receiving a fluid to be tested; (c) a first flow path for receiving the fluid from the inlet, wherein the first flow path comprises an optical chamber having at least one optical window for performing spectrometry on the fluid; (d) a second flow path for receiving the fluid from the inlet, wherein the second flow path comprises a biosensor chamber having at least one biosensor for performing tests on the fluid; and (e) a vent for facilitating airflow out of the first flow path and the second flow path when the inlet receives the fluid

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1A is a schematic drawing showing a top view of a joint-diagnostic spectroscopic and biosensor apparatus suitable for measurement of a fluid sample according to a first embodiment of the invention;

FIG. 1B is a cross-sectional view through the apparatus shown in FIG. 1A along line B-B;

FIG. 1C is a cross-sectional view through the apparatus shown in FIG. 1A along line C-C;

FIG. 2 is a schematic drawing showing a top view of a joint-diagnostic spectroscopic and biosensor apparatus suitable for measurement of a fluid sample according to a second embodiment of the invention;

FIG. 3 is a schematic drawing showing a top view of a joint-diagnostic spectroscopic and biosensor apparatus suitable for measurement of a fluid sample according to a third embodiment of the invention; and,

FIG. 4 is a schematic drawing showing a top view of a joint-diagnostic spectroscopic and biosensor apparatus that includes a built-in calibration system for the biosensors, and is suitable for measurement of a fluid sample according to a fourth embodiment of the invention.

### DETAILED DESCRIPTION OF PREFERRED ASPECTS OF THE INVENTION

Some embodiments of the invention provide a single apparatus or cartridge that is suitable for both spectroscopic and biosensor measurement of a fluid sample, for example without limitation, a blood sample. Those skilled in the art will appreciate that although blood is used as an example of a fluid analyzed, measured or tested using the apparatus, other fluids for example without limitation, blood, serum, plasma, cerebrospinal fluid, synovial fluid, lymphatic fluid, calibration fluid, and urine, could also be used with the apparatus. Once the blood is transferred to the apparatus, the apparatus can be inserted into a slot in a diagnostic measurement instrument for rapid blood analysis. Because the apparatus is small and no pretreatment of the blood is necessary, the diagnostic measurement instrument may be in the form of an inexpensive hand-held instrument, which could be used at the site of patient care.

In some very specific embodiments, the apparatus is provided with two independent flow paths for the analysis of blood: a first flow path that includes an optical chamber that is specifically designed to reduce the average attenuation of electromagnetic radiation (EMR) due to scattering of EMR by the red blood cells in a blood sample, without having to hemolyze the red blood cells using sound waves or hemolyzing chemicals; and, a second flow path that includes a biosensor chamber that is specifically designed with at least one active surface, such as a chemical or ionic sensitive surface that is exposed to the blood. Those skilled in the art will appreciate that biosensors include various transducer arrangements that convert certain properties of a sample into an electrical signal. Biosensors may comprise, for example without limitations, field-effect transistors, ion-selective membranes, membrane-bound enzymes, membrane-bound antigens, and membrane-bound antibodies.

In such embodiments the optical chamber is designed to spread blood into a thin film, thereby reducing the incidences of trapped air bubbles in the blood sample in the optical chamber. Instead air bubbles are pushed through the optical chamber and guided out of the apparatus through a vent. In the same embodiments, the second flow path includes at least one biosensor. The optical chamber provides spectroscopic blood measurements for determination of, for example without limitation, Hb species, and the biosensor provides blood measurements for determination of, for example without limitation, blood pH. The apparatus is particularly useful for, for example without limitation, a combination of blood gas measurement and co-oximetry.

Moreover, in some embodiments blood within the optical chamber is further isolated from contamination by room air by providing an inlet transition cavity and an overflow chamber at a respective entrance and exit of the optical chamber. In use, blood in the inlet transition cavity and the overflow chamber serve as barriers between blood in the optical chamber and room air, thereby isolating the blood in the optical chamber from oxygen contamination. In the rare incident of a trapped air bubble, those skilled in the art will appreciate that various calibration algorithms for many specific analytes measured in the blood sample can be developed that could compensate for measurement inaccuracies caused by trapped air bubbles, except for those analytes such as the partial pressure of oxygen and oxy-hemoglobin, which become falsely elevated as a result of oxygen introduced into the blood sample from the air bubble. Similarly in the same embodiments, the biosensor chamber is also isolated from contamination by room air by providing an inlet transition cavity and an overflow chamber at a respective entrance and exit of the biosensor chamber.

The apparatus may also include at least one visible fill line or indicator serving as a marker providing a user with a visual Boolean indicator relating to the sufficiency of the blood sample in the optical chamber and biosensor chamber. Briefly, in some embodiments, the visible fill line is located in a position in and/or beyond the overflow chamber that is indicative of whether or not a volume of blood drawn into the apparatus is present in sufficient amount to: i) ensure that the blood in the optical chamber and biosensor chamber is substantially free from contaminants that may have been introduced during the filling of the apparatus with blood; and/or, ii) ensure that there is an effective amount of blood surrounding the optical chamber and biosensor chamber to isolate the blood in the optical chamber and biosensor chamber from room air.

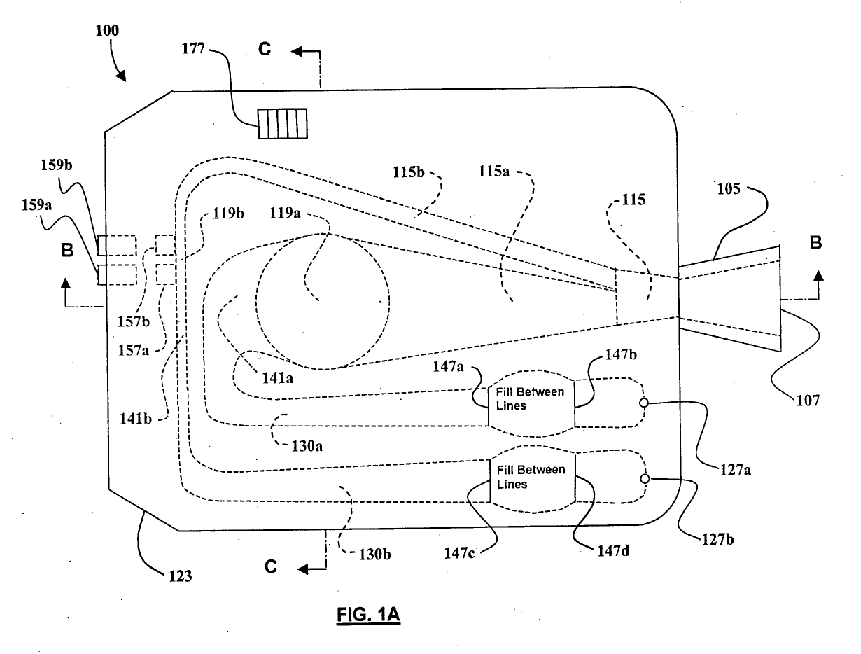

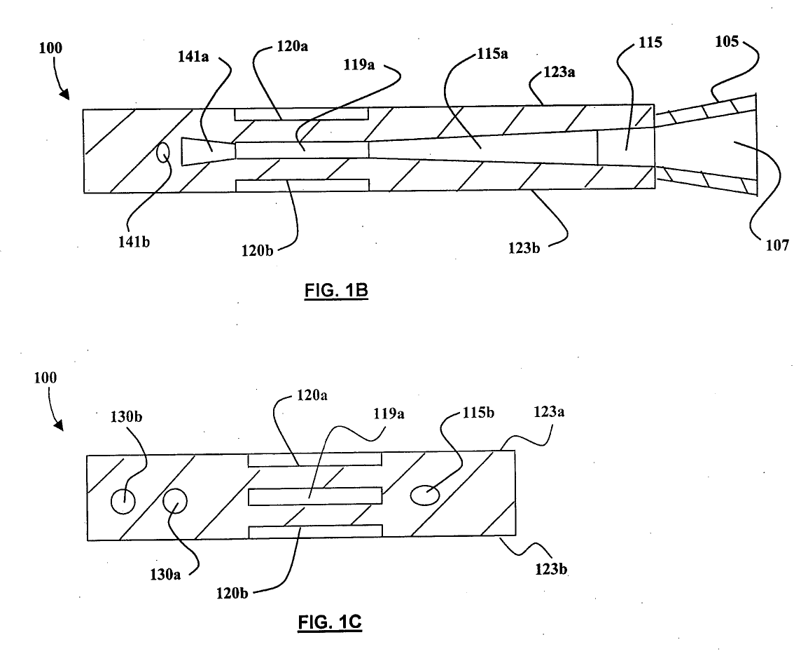

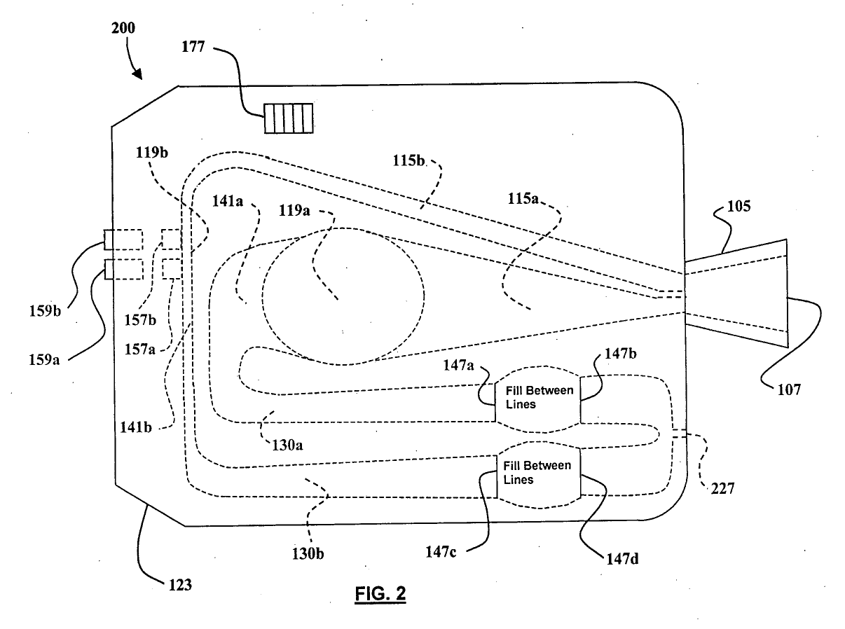

In accordance with an embodiment of the invention, a very specific example of a apparatus suitable for spectroscopic and biosensor measurements of a blood sample is shown in FIGS. 1A, 1B and 1C. Specifically, FIG. 1A is a schematic drawing illustrating the top view of an apparatus 100, FIG. 1B is a cross-sectional view through the apparatus 100 along line B-B in FIG. 1A, and FIG. 1C is a cross-sectional view through the apparatus 100 along line C-C in FIG. 1A.

Referring to FIG. 1A, the inlet transition cavity 115 is split into two independent flow paths via two inlet transition paths 115a and 115b. Spectroscopic inlet transition path 115a (first inlet transition path) serves as a transition between the inlet transition cavity 115 and the optical chamber 119a, while biosensor inlet transition path 115b (second inlet transition path) serves as a transition between the inlet transition cavity 115 and the biosensor chamber 119b. Those skilled in the art will appreciate that the inlet transition paths 115a and 115b could be extended to replace the inlet transition cavity 115, as is the case in the embodiment shown in FIG. 2, which does not contain an inlet transition cavity 115 as shown in FIG. 1. The spectroscopic inlet transition path 115a also provides a barrier between room air and blood in the optical chamber 119a. The spectroscopic inlet transition path 115a is tapered towards the optical chamber 119a so as to have a diminishing depth and an increasing width relative to the diameter of a tapered tube 105 in the direction of the optical chamber 119a from the tapered tube 105. Moreover in use, blood remaining in the inlet transition path 115a serves as a barrier between room air and the blood in the optical chamber 119a through which air cannot easily diffuse toward the blood in the optical chamber 119a. Similarly, the biosensor inlet transition path 115b provides a barrier between room air and the blood in the biosensor chamber 119b. Moreover in use, blood remaining in the biosensor inlet transition path 115b serves as a barrier between room air and the blood in the biosensor chamber 119b through which air cannot easily diffuse toward the blood in the biosensor chamber 119b. In this particular embodiment, the tapered tube 105 is provided to accept the male end of a syringe and defines the inlet 107.

Referring to FIG. 1B, the overflow chamber 141a is similarly provided to serve as a transition between the outlet vent 127a and the optical chamber 119a and as a barrier between room air and blood in the optical chamber 119a during operation. In this particular embodiment, the overflow chamber 141a has a complementary design to that of the inlet transition cavity 115a. That is, the overflow chamber 141a is flared away from the optical chamber 119a so as to have an increasing depth and a decreasing width in the direction away from the optical chamber 119. In this particular embodiment, the volume of the overflow chamber 141a is larger than that of the optical chamber 119a, such that during operation, filling the overflow chamber 141a is helpful in ensuring that blood in the optical chamber is substantially free from contamination and effectively isolated from room air that may enter via the outlet vent 127a. In terms of total volume, the overflow chamber 141a has a volume that is preferably greater than the approximate volume of the optical chamber 119a. The overflow chamber 141b is similarly provided to serve as a transition between the outlet vent 127b and the biosensor chamber 119b and to provide a barrier between room air and blood in the biosensor chamber 119b during operation. In this particular embodiment, the volume of the overflow chamber 141b is larger than that of the biosensor chamber 119b, such that during operation filling the overflow chamber 141b helps to ensure that blood in the biosensor chamber is substantially free from contamination and effectively isolated from room air that may enter via the outlet vent 127b.

Before the apparatus 100 is employed during a blood test, room air is present within the internal volume (i.e. within the inlet transition cavity 115, the inlet transition paths 115a and 115b, the optical chamber 119a, the biosensor chamber 119b, and the overflow chambers 141a and 141b, etc.). The room air contains oxygen and other gases that could contaminate a blood sample drawn into the apparatus 100. In operation, blood flows through the inlet 107 after blood in a syringe (not shown) is provided to the inlet 107 by fitting the male end of the syringe to the tapered tube 105, and applying force to the plunger of the syringe. The leading surface of the inflowing blood is exposed to the room air within the apparatus 100, which is simultaneously being forced out of the vents 127a and 127b by the inflow of blood. The vents 127a and 127b provide flow paths for the room air that moves away from the inflow of blood. Eventually, enough blood enters the apparatus 100 to fill the overflow chambers 141a and 141b, thereby forcing room air out of the apparatus 100 through the vents 127a and 127b. At that point, blood that was exposed to the room air during the filling process will typically be in the overflow chambers 141a and 141b, and not within the optical chamber 119a or the biosensor chamber 119b, and internal pressure impedes back flow of the blood. As noted previously, the blood in the inlet transition paths 115a and 115b and the blood in the overflow chamber 141a and 141b helps to isolate the blood in the optical chamber 119a and the biosensor chamber 141b respectively, from further contamination from the room air. Once the blood is injected into the apparatus, it is ready for measurement by inserting the apparatus into a slot in a diagnostic measurement instrument (not shown). The end of the apparatus with the electrical contacts 159a and 159b shown in FIG. 1A is inserted first, and the inlet 107 remains outside the slot of the diagnostic measurement instrument. FIGS. 1B and 1C are respective cross-sectional views along corresponding lines B-B and C-C provided in FIG. 1A.

In specific embodiments, the barcode pattern 177 may be marked on the apparatus to provide a means of identifying a particular apparatus 100. Additionally and/or alternatively, the barcode pattern 177 may also, without limitation, carry information relating to at least one of calibration information for the biosensors 157a, 157b, the production batch number of the biosensors 157a, 157b and/or the entire apparatus 100. Those skilled in the art will appreciate that the biosensors 157a and 157b in one apparatus 100 from a respective production batch can be calibrated, and the calibration algorithm developed can be stored in the diagnostic measurement instrument and linked to the barcode pattern 177, which could be marked on each apparatus 100 from the respective production batch. Moreover, those skilled in the art will also appreciate that by linking the calibration algorithm to a barcode pattern 177, there is no need to calibrate the biosensors 157a and 157b in each apparatus 100.

With further specific reference to FIG. 1B, the interior of optical chamber 119a is much thinner in depth than the average diameter of the interior of the tapered tube 105 and the broad end of the inlet transition cavity 115a. In some embodiments, the depth of the optical chamber 119, being the internal distance between the respective interior faces of the top and bottom wall-portions 120a and 120b, ranges approximately from about 0.02 mm to about 0.2 mm, whereas the average inside diameter of the tapered tube is from about 2 mm to about 5 mm, in the specific embodiment, which corresponds to the outside diameters of the male end of a syringe. Light scattering caused by red blood cells is more prevalent when the depth of the optical chamber 119a is more than 0.1 mm, and so a depth of less than 0.1 mm is preferred. If the depth is less than 0.02 mm the natural viscosity of blood may reduce how effectively blood can be spread evenly through the optical chamber 119. Specifically, the diameter in the top view, shown in FIG. 1A of the optical chamber 119a ranges approximately, without limitation, between about 2 mm to about 10 mm. Those skilled in the art will appreciate that the circular shape of the optical chamber 119a is not essential, and an example of an oval shape is provided in the embodiment shown in FIG. 2. The biosensor chamber 119b could be in the shape of a tube as shown as 119b in FIGS. 1A & 1B, with the biosensors 157a and 157b exposed to the lumen of the tube, in order to facilitate contact between the biosensors and the blood. Since light scatter is not critical to the performance of the biosensors 157a and 157b, those skilled in the art will appreciate that the diameter of the biosensor chamber 119b could be larger than the depth of the optical chamber. In the preferred embodiment, the volumes of the two fluid paths are approximately equal, but those skilled in the art will appreciate that this is not essential.

With further specific reference to FIG. 1B and also FIG. 1C, the top and bottom wall-portions 120a and 120b of the housing 123 are transparent (or translucent), and define the optical chamber 119a. Further, in this preferred embodiment, the top and bottom wall-portions 120a and 120b are recessed with respect to the corresponding top and bottom surfaces 123a and 123b of the housing 123, in order to protect the exterior faces of the top and bottom wall-portions 120a and 120b from scratches, although those skilled in the art will appreciate that this is not essential. It should be understood that the cross-sectional areas shown are non-limiting examples, and those skilled in the art will appreciate that other cross-sectional areas could be used. Those skilled in the art will also appreciate that the internal walls of the optical chamber 119a do not have to be exactly parallel because the calibration algorithms for blood measurements can be developed to accommodate variability in depth of the optical chamber 119.

With further specific reference to FIG. 1A, the overflow chamber 141a is fluidly connected to an outlet tube 130a, which terminates at vent 127a, and the biosensor chamber 141b is fluidly connected to an outlet tube 130b, which terminates at vent 127b. Optionally, the outlet tubes 130a and 130b include respective first and second visible fill lines 147a and 147b, and 147c and 147d, respectively. Between the visible fill lines 147a and 147b, and also between visible fill lines 147c and 147d, the outlet tubes 130a and 130b respectively, bulge, creating volumes large enough to facilitate filling between the fill lines. In this particular embodiment, proper use requires that enough blood flows into the apparatus 100 to at least pass the first fill lines 147a and 147c. Overfilling past the second fill lines 147b and 147d will not compromise the blood sample within the optical chamber 119a and the biosensor chamber 119b respectively, but excess filling may cause blood to flow through the vent 127a and/or 127b onto the top surface 123a of the housing, thereby contaminating the top surface 123a with potentially biologically hazardous material. Those skilled in the art will appreciate that the fill lines provide a guide to the user, and they should be in plain view when the apparatus is fully inserted into the slot of the diagnostic measurement instrument, particularly if the blood is injected into the apparatus 100 after the apparatus 100 is fully inserted into the slot of the diagnostic measurement instrument. Those skilled in the art will also appreciate that the fill lines could be on the surface 123a and/or 123b, depending on the orientation or the apparatus 100 in the slot of the diagnostic measurement instrument.

Referring to FIG. 2, shown is a top view of a apparatus 200 suitable for both spectroscopic and biosensor measurements of a blood sample according to a second embodiment of the invention. The apparatus 200 illustrated in FIG. 2 is similar to the apparatus 100 illustrated in FIG. 1, and accordingly, elements common to both share common reference numerals. For brevity, the description of FIG. 1 is not repeated with respect to FIG. 2. The primary difference, illustrated in FIG. 2, is that the vents 127a and 127b shown in FIG. 1 are now merged into a single vent 227 and located on the same side of the housing 123 as the inlet 107. Those skilled in the art will appreciate that the vent can be located in several positions in the housing, but it is preferably in a position where the risk of contaminating the slot of the diagnostic measurement instrument with blood is minimized. Also, the inlet transition cavity 115 shown in FIG. 1 is replaced by inlet transition paths 115a and 115b.

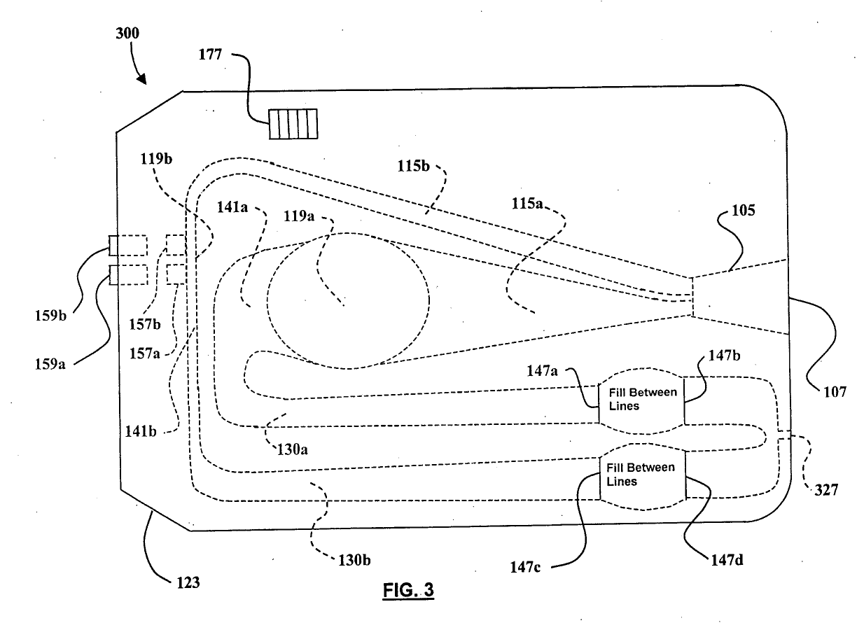

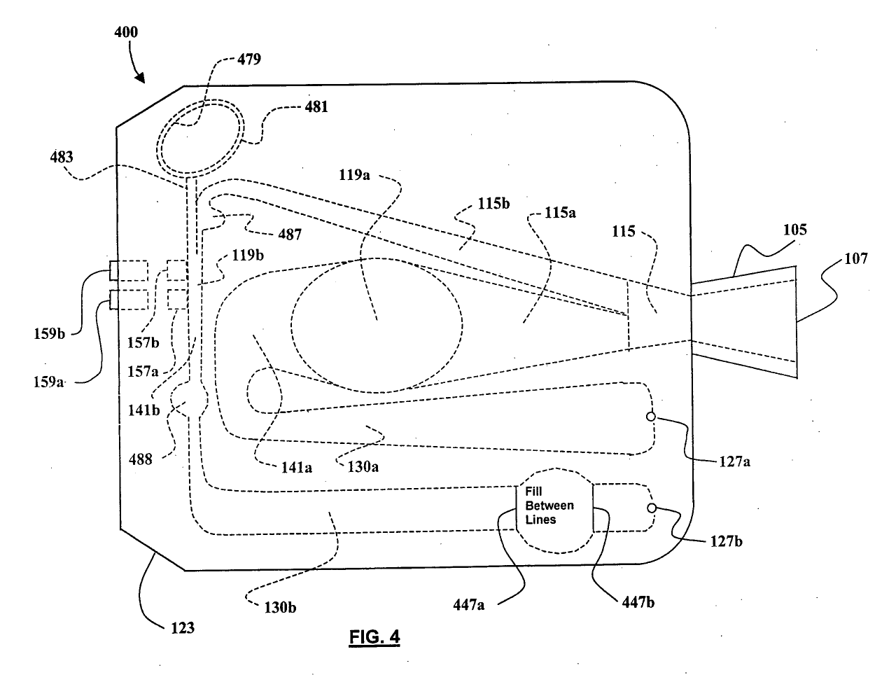

Referring to FIG. 3, shown is a top view of a apparatus 300 suitable for spectroscopic and biosensor measurements of a blood sample according to a third embodiment of the invention. The apparatus 300 illustrated in FIG. 3 is similar to the apparatus 100 illustrated in FIG. 1, and accordingly, elements common to both share common reference numerals. For brevity, the description of FIG. 1 is not repeated with respect to FIG. 3. The primary difference, illustrated in FIG. 3, is that the vents 127a and 127b shown in FIG. 1 are now merged into a single vent 327 and located on the same side of the housing 123 as the inlet 107, and the inlet tapered tube 105 is completely contained within the housing 123. Also, the inlet transition cavity 115 shown in FIG. 1 is replaced by inlet transition paths 115a and 115b.

As an alternative to using pre-calibrated biosensors, the fourth embodiment of the invention is shown in FIG. 4. The description that follows relates to a non-limiting example, of a method that may be used to calibrate the biosensors 157a and 157b in FIG. 4, in each apparatus 400.

Referring to FIG. 4, shown is a top view of a apparatus 400 suitable for both spectroscopic and biosensor measurement of a blood sample according to the fourth embodiment of the invention. The apparatus 400 illustrated in FIG. 4 is similar to the apparatus 100 illustrated in FIG. 1, and accordingly, elements common to both share common reference numerals. For brevity, the description of FIG. 1 is not repeated with respect to FIG. 4. The apparatus 400 includes additional features that aid in the calibration of the biosensors 157a, 157b and control the inflow of calibration fluid. More specifically, the apparatus includes a calibration pouch or reservoir 479 containing calibration fluid, fitted inside a calibration pouch cavity 481. The apparatus 400 also includes a first capillary break 487 in the second flow path, and a second capillary break 488 also in the second flow path. Capillary breaks provide widened portions in which capilliary action stops. Regarding the first flow path, the apparatus 400 also includes an outlet tube 130a with increasing volume towards the vent 127a, and no fill lines are included. The fill lines are only included in the outlet tube 130b of the second flow path. The visible fill lines 447a and 447b provide an indication that the calibration fluid, which should be distinguishable from blood, is flushed from the biosensor chamber 119b. In operation, blood provided to the apparatus 400 via the transition cavity 115 will, after it traverses biosensor inlet transition path 115b and first capillary break 487, push out the calibration fluid within biosensor chamber 119b, past second capillary break 488, and through second outlet tube 130b until this calibration fluid passes fill line 447a. As mentioned before, the fill lines should be in plain view when the apparatus 400 is fully inserted into the slot of the diagnostic measurement instrument.

With further reference to FIG. 4, the first capillary break 487 is in the form of a bulge between the second inlet transition path 115b and the biosensor chamber 119b. The second capillary break 488 is also in the form of a bulge and is located between the biosensor chamber 119b and the second outlet tube 430b, and within the overflow chamber 141b. The calibration pouch 479 is connected to the second flow path into the biosensor chamber 119b via a calibration conduit 483. The calibration reservoir or pouch 479 contains a calibration fluid used to calibrate the biosensors 157a, 157b before intake of a blood sample. When pressure is applied to a flexible surface of the pouch cavity 481, the calibration pouch 479 ruptures and the calibration fluid is released into the biosensor chamber 119b via the conduit 483, and the calibration fluid makes contact with biosensors 157a, 157b that measure the fluid. The first capillary break 487 impedes the calibration fluid from flowing into the second inlet transition path 115b, and the second capillary break 488 impedes the calibration fluid from flowing into the second outlet capillary tube 130b. In this specific embodiment, the cross-sectional dimensions of the biosensor chamber should be small enough to promote capillary action, which is required to maintain the calibration fluid between the capillary breaks 487 and 488. Since the calibration fluid is a known substance having known properties, the initial measurements of the calibration fluid, made by the biosensors 157a and 157b, are then employed by a calibration algorithm that enables more accurate interpretation of subsequent biosensor readings of a blood sample. It will be appreciated by those skilled in the art that the calibration pouch 479 can include a weakened wall portion designed to rupture when pressure is applied to the calibration pouch cavity 481, and a vacuum could be created within the pouch cavity 481 when the pressure is released. The vacuum could be used to withdraw some of the calibration fluid into the pouch cavity 481, and the remaining calibration fluid would be flushed from the biosensor chamber 119b with blood by connecting the syringe containing the blood to the inlet 107, and applying pressure to the plunger of the syringe. Those skilled in the art will also appreciate that even without the creation of a vacuum within the pouch cavity 481, the blood expelled from the syringe (after calibration) would be sufficient to flush out the calibration fluid from the biosensor chamber 119b. In this situation, it will not be necessary to release the pressure on the calibration pouch 479, since the creation of a vacuum within the calibration pouch cavity 481 is not essential. Those skilled in the art will appreciate that within the slot of a diagnostic measurement instrument, a “V” shaped groove could be used to squeeze the calibration pouch cavity 481, after the apparatus 400 is fully inserted into the slot of the diagnostic measurement instrument. Those skilled in the art will also appreciate that in order for the “V” shaped groove in the diagnostic measurement instrument to operate properly, the calibration pouch 479 and the pouch cavity 481 could bulge at the surface 123a and/or 123b, and the surface of the calibration pouch cavity 481 should be flexible. Moreover, as alternative means of releasing the contents of the calibration pouch 479, those skilled in the art will also appreciate that a plunger or a rotating cam in the diagnostic measurement instrument, could be used as mechanisms to apply pressure, or to apply and release pressure, on the calibration pouch cavity 481. The apparatus would be filled with blood after calibration of the biosensors.

As already mentioned in the example of a method of calibrating the biosensors 157a and 157b described in connection with FIG. 4, the apparatus 400 would be filled with blood after the calibration fluid from the calibration pouch 479 is allowed to flood the biosensors, in order to calibrate the biosensors 157a and 157b. Those skilled in the art will appreciate that calibration of the biosensors 157a and 157b may also be performed after the apparatus 400 is filled with blood, up to the first capillary break 487.

With respect to spectroscopic measurements, the examples shown describe an apparatus that operates in transmission mode. Those skilled in the art will appreciate that the spectroscopic apparatus can also operate in reflectance mode by placing a reflecting member on one side of the optical chamber 119a, such that the EMR transmitted through the sample would be reflected off the reflecting member, and the reflected EMR would enter the sample for the second time. In a diagnostic measurement instrument operating in the reflectance mode, both the EMR source and the photodetector would be on the same side of the optical chamber 119a. Moreover, those skilled in the art will also appreciate that instead of using a reflecting member in the diagnostic measurement instrument, one side of the wall-portions (120a or 120b) of the optical chamber 119a could be coated with a reflecting material.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention. Numerous modifications and variations of the present invention are possible in light of the above teachings. It is therefore to be understood that within the scope of the appended claims, the invention may be practiced otherwise than as specifically described herein.

1. A fluid measurement apparatus comprising:
a housing;
an inlet within the housing for receiving a fluid to be tested;
a first flow path for receiving the fluid from the inlet, wherein the first flow path comprises an optical chamber having at least one optical window for performing spectrometry on the fluid;
a second flow path for receiving the fluid from the inlet, wherein the second flow path comprises a biosensor chamber having at least one biosensor for performing tests on the fluid; and
a vent for facilitating airflow out of the first flow path and the second flow path when the inlet receives the fluid.

2. The fluid measurement apparatus as defined in claim 1, wherein the inlet is dimensioned to encompass a male end of a syringe to receive the fluid therefrom.

3. A fluid measurement apparatus according to claim 1 comprising at least one visible fill line for indicating a total amount of the blood received into the first flow path and the second flow path.

4. A fluid measurement apparatus according to claim 1 further comprising a calibration reservoir containing a calibration fluid and having a release means for releasing the calibration fluid into the second flow path for measurement by the at least one biosensor, the calibration fluid having at least one known property for measurement by the at least one biosensor.

5. A fluid measurement apparatus according to claim 1, wherein the second flow path includes a capillary break for restricting flow of calibration fluid.

6. A fluid collection and measurement apparatus according to claim 1, wherein an average depth of the optical chamber is in an approximate range of about 0.02 mm to about 0.2 mm.

7. A fluid collection and measurement apparatus according to claim 1, wherein the first flow path includes an overflow chamber, the overflow chamber having an overflow chamber volume at least equal to an optical chamber volume of the optical chamber.

8. A fluid collection and measurement apparatus according to claim 1, wherein the second flow path includes an overflow chamber, the overflow chamber having an overflow chamber volume at least equal to a biosensor chamber volume of the biosensor chamber.

9. A fluid measurement apparatus according to claim 1 further comprising a reflective coating on a wall-portion of the optical chamber.

10. A fluid measurement apparatus according to claim 1 further comprising a barcode containing at least information regarding calibration of a biosensor.

11. A fluid measurement apparatus according to claim 1 further comprising a calibration pouch, containing a calibration fluid, that is arranged in fluid connection with the second flow path upstream of the at least one biosensor.

12. A fluid measurement apparatus according to claim 1, wherein the calibration pouch is enclosed in a calibration pouch cavity, and wherein at least a portion of the wall of the calibration pouch cavity is flexible.

13. A fluid measurement apparatus according to claim 11, wherein the calibration pouch is enclosed in a bulging calibration pouch cavity, and wherein at least a portion of the wall of the bulging calibration pouch cavity is flexible.

14. A fluid measurement apparatus according to claim 1, wherein the average inside diameter of the inlet is between about 2 mm and about 5 mm.

15. A fluid measurement apparatus according to claim 1, wherein the biosensor comprises a transducer for converting at least one property of the fluid into an electrical signal.

16. A fluid measurement apparatus according to claim 15 wherein the transducer comprises at least one active surface for contacting the fluid.

17. A fluid measurement apparatus according to claim 16 wherein the at least one active surface is one of a chemical sensitive surface or an ionic sensitive surface.

18. A fluid measurement apparatus according to claim 1, wherein the at least one biosensor comprises, at least one of a field-effect transistor, an ion-selective membrane, a membrane-bound enzyme, a membrane-bound antigen, or a membrane-bound antibody.
